(19) United States
(12) Patent Application Publication
(10) Pub. No.: US 2002/0048727 A1
(43) Pub. Date: Apr. 25, 2002

(54) Method for forming a refractive-index-patterned film for use in optical device manufacturing

(76) Inventors: Yan Zhou, Pleasanton, CA (US); Seng-Tiong Ho, Wheeling, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/884,691

(22) Filed: Jun. 19, 2001

Related U.S. Application Data
(60) Provisional application No. 60/242,188, filed on Oct. 20, 2000.

(51) Int. Cl. G02B 6/10

(52) U.S. Cl. 430/290; 385/146

(57) ABSTRACT

A process for forming a refractive-index-patterned film for use in optical device manufacturing. The process includes forming a photosensitive lead-silicate-containing film on a substrate (e.g., a silicon, quartz or glass substrate) using, for example, a conventional and inexpensive sol-gel process. A predetermined portion of the lead-silicate-containing film is subsequently exposed to ultra-violet (UV) light through a patterned mask (e.g., a patterned amplitude mask, patterned phase mask or patterned gray scale mask). The UV exposure modifies the refractive index of the predetermined portion, thereby forming a refractive-index-patterned lead-silicate-containing film suitable for use in optical device manufacturing. The use of a photosensitive lead-silicate-containing film enables a relatively large refractive index modification upon exposure to UV light. A vertically tapered waveguide region that includes a substrate with a sloped upper surface protrusion and a refractive-index-patterned lead-silicate-containing film can be formed using the above described process. The refractive-index-patterned lead-silicate film is disposed on the substrate and sloped upper surface protrusion and is, therefore, vertically tapered (i.e., thinned) over the sloped upper surface protrusion. PATENT

### CROSS-REFERENCES TO RELATED APPLICATIONS

This application claims priority from U.S. provisional application No. 60/242,188, filed Oct. 20, 2000, which is hereby fully incorporated by reference.

### BACKGROUND OF THE INVENTION

1. Field of the Invention

The present invention relates, in general, to optical device manufacturing and, in particular, to methods for forming refractive-index-patterned films.

2. Description of the Related Art

The manufacturing of optical devices and circuits (e.g., optical gratings, integrated photonic circuits and opto-electronic devices/circuits) typically requires a process for forming a device region (e.g., an integrated waveguide region) with a refractive index that differs from adjacent device regions. Conventional processes for the formation of integrated waveguide regions involve the use of multi-step techniques combining deposition, photolithography, etching, diffusion or ion implantation. Such conventional multi-step processes can be expensive and complicated.

Other conventional methods proposed for use in optical device manufacturing form device regions from refractive-index-patterned films that are themselves prepared by imprinting a photosensitive polymer film. However, the photosensitive polymer films used in such conventional processes suffer from several drawbacks, such as (i) polymer instability; (ii) undesirable absorption around a wavelength of 1.5 microns due to the presence of C—H bonds; (iii) inability to handle high power light signals; and (iv) an undesirably small refractive index modification of approximately 0.005 upon imprinting. See, U.S. provisional application No. 60/242,188, filed October 20, for a further discussion of the conventional processes and associated drawbacks.

Still needed in the field, therefore, is a method for the formation of a refractive-index-patterned film for use in optical device manufacturing that is inexpensive and that provides a relatively large refractive index modification.

### SUMMARY OF THE INVENTION

The present invention provides a refractive-index-patterned film formation process, for use in optical device manufacturing, with a relatively large (e.g., in the order of 0.1) refractive index modification upon imprinting. Further, the present invention inexpensively provides such a process.

A process according to one exemplary embodiment of the present invention includes forming a photosensitive lead-silicate-containing film on a substrate (e.g., a silicon, quartz or glass substrate). The photosensitive lead-silicate-containing film can be formed using conventional, inexpensive sol-gel processes. A predetermined portion of the lead-silicate-containing film is subsequently exposed to ultra-violet (UV) light through a patterned mask (e.g., a patterned amplitude mask, patterned phase mask or patterned gray scale mask). The UV exposure modifies the refractive index of the predetermined portion, thereby forming a refractive-index-patterned lead-silicate-containing film suitable for use in optical device manufacturing. The use of a photosensitive lead-silicate-containing film enables a relatively large refractive index modification upon exposure to UV light.

Another exemplary embodiment according to the present invention is a vertically tapered waveguide region that includes a substrate with a sloped upper surface protrusion and a refractive-index-patterned lead-silicate-containing film. The refractive-index-patterned lead-silicate film is disposed on the substrate and sloped upper surface protrusion and is vertically tapered (i.e., thinned) over the sloped upper surface protrusion. Such a vertically tapered waveguide region can be formed using the inventive methods described in this disclosure.

A better understanding of the features and advantages of the present invention will be obtained by reference to the following detailed description that sets forth illustrative embodiments, in which the principles of the invention are utilized, and the accompanying drawings.

### BRIEF DESCRIPTION OF THE DRAWINGS

FIG. 1 is a flow diagram illustrating a process according to one exemplary embodiment of the present invention;

FIGS. 2A and 2B are top and cross-sectional side diagrams illustrating a stage of a process in accordance with one exemplary embodiment of the present invention;

FIGS. 3A and 3B are top and cross-sectional side diagrams illustrating another stage of a process according to one exemplary embodiment of the present invention;

FIG. 4 is a graph of refractive index versus lead content for an exemplary photosensitive lead-silicate-containing film both before exposure to UV light (circles) and after exposure to UV light (squares);

FIG. 5 is a schematic diagram of a tapered patterned gray scale mask;

FIG. 6 is a cross-sectional side view of a refractive-index-patterned film formed on a substrate with an upper surface projection in a process according to one exemplary embodiment of the present invention; and

FIGS. 7A and 7B are top and cross-sectional side views, respectively, of a vertically tapered waveguide region according to another exemplary embodiment of the present invention.

### DESCRIPTION OF THE SPECIFIC EMBODIMENTS OF THE INVENTION

To be consistent throughout the present specification and for clear understanding of the present invention, the following definition is hereby provided for a term used therein:

The term “refractive-index-patterned film” refers to a film (e.g., a lead-silicate-containing film) that includes at least one film portion of a predetermined pattern (design), whose refractive index was modified (i.e., increased or decreased) following formation of the film.

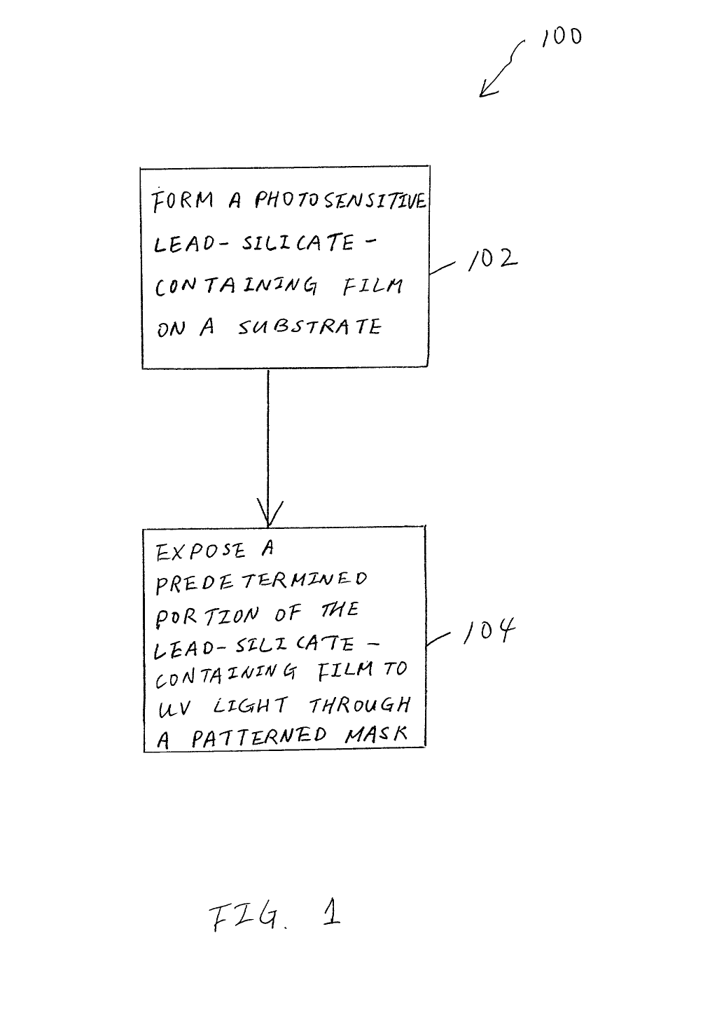

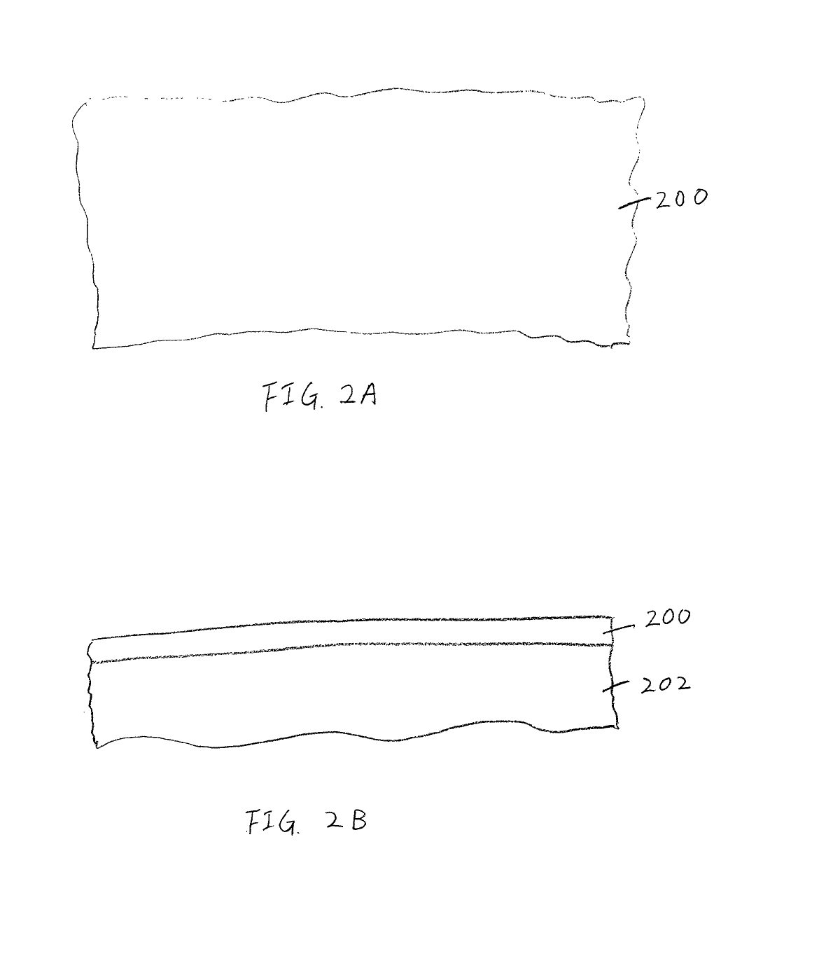

Process 100 includes first forming a photosensitive lead-silicate-containing film 200 on a substrate 202, as illustrated at step 102 of FIG. 1 and in FIGS. 2A-2B. Substrate 202 can be any suitable substrate known to those skilled in the art. For example, substrate 202 can be a quartz, silica-on-silicon, gallium arsenide (GaAs), indium phosphide (InP), gallium nitride (GaN), lithium niobate (LiNbO₃), barium titanate (BaTiO₃) or sapphire (Al₂O₃) substrate.

Photosensitive lead-silicate-containing film 200 is an amorphous film containing silicon oxides (SiO₂) and lead oxides (e.g., PbO). The presence of silicon oxides and lead oxides enables the refractive index of photosensitive lead-silicate-containing film 200 to be significantly modified by exposure to UV light. In this respect, photosensitive lead-silicate-containing films with a lead content between 30 molar % and 60 molar % are useful in providing a beneficial degree of photosensitivity. Other suitable lead contents can, however, be employed in processes according to the present invention.

Photosensitive lead-silicate-containing film 200 can optionally include dopants that enhance the material properties (e.g., refractive index, melting temperature and optical gain properties) of photosensitive lead-silicate-containing film 200. Such dopants include, but are not limited to, germanium, titanium, boron, phosphorus, rare earth elements (e.g., Er, Nd, Yb and Ce) and combinations thereof. The thickness of photosensitive lead-silicate-containing film 200 can be in the range of 0.5 microns to 20 microns.

Photosensitive lead-silicate-containing film 200 can be advantageously formed using conventional sol-gel techniques known to those skilled in the art. In one exemplary conventional sol-gel technique, lead acetate diluted in acetic acid at a molar ratio of 1:20 (lead acetate:acetic acid) is added to a 1:4 molar ratio mixture of tetraorthosilicate (TEOS) and ethanol to form a lead-silicate precursor mixture. Water is subsequently added to the lead-silicate precursor mixture at a molar ratio of 4:1 (water:lead-silicate precursor mixture) to initiate hydrolysis, condensation and gelation reactions and, thereby, to form a lead-silicate sol-gel mixture.

The lead-silicate sol-gel mixture is then applied to substrate 202 by any method known to those skilled in the art (including spin-coating at 3000 to 4000 rpm and dipcoating). The lead-silicate sol-gel mixture that has been applied to substrate 202 is subsequently annealed at an elevated temperature to form photosensitive lead-silicate-containing film 200. The annealing can be conducted using a rapid thermal annealing technique and an elevated temperature in the range of 500° C. to 900° C. for a time period of 15 seconds to two minutes.

When a spin-coating method is employed to apply the lead-silicate sol-gel mixture to substrate 202, the thickness of photosensitive lead-silicate-containing film 200 will depend on the viscosity of the lead-silicate sol-gel mixture, the rotation speed of the spin-coating method and the process conditions (e.g., temperature and time) of the thermal annealing step. However, a typical thickness for photosensitive lead-silicate-containing film 200 is in the range of from about 0.1 microns to 0.2 microns. Multiple iterations of spin-coating and thermal annealing can, therefore, be employed to apply a multi-layered photosensitive lead-silicate-containing film 200 of a desired thickness (e.g., 0.5 microns to 20 microns).

The refractive index of such a multi-layered photosensitive lead-silicate-containing film can be varied in the vertical direction (i.e., normal to the film's surface) to provide a photosensitive lead-silicate-containing film with a vertical refractive index distribution. Such a vertical refractive index distribution can be obtained by manipulating the lead content (or the content of other refractive index determining dopants, such as titanium and germanium) in each of the multi-layers, the viscosity of the lead-silicate sol-gel mixture used to form each of the multi-layers and/or the rotation speed of the spin-coating method used to apply each of the multi-layers.

As is well known to those skilled in the art, photosensitive lead-silicate-containing films can be formed on a substrate using sol-gel techniques that differ from that described above. For example, the molar ratios described above can be varied and the chemical composition of the lead-silicate precursor mixture can be altered. Further, the process parameters used to apply and anneal the lead-silicate sol-gel mixture can be adjusted from those detailed above.

Sol-gel techniques are especially beneficial in processes according to the present invention since sol-gel techniques are extremely low cost and can be used to produce photosensitive-lead-silicate-containing films with a wide variety of chemical compositions and hence, a wide variety of refractive indices and photosensitivities. However, photosensitive lead-silicate-containing film 200 can also be applied by other suitable techniques known to those skilled in the art, such as flame hydrolysis techniques, chemical vapor deposition techniques, sputtering techniques, thermal evaporation techniques and electron beam evaporation techniques.

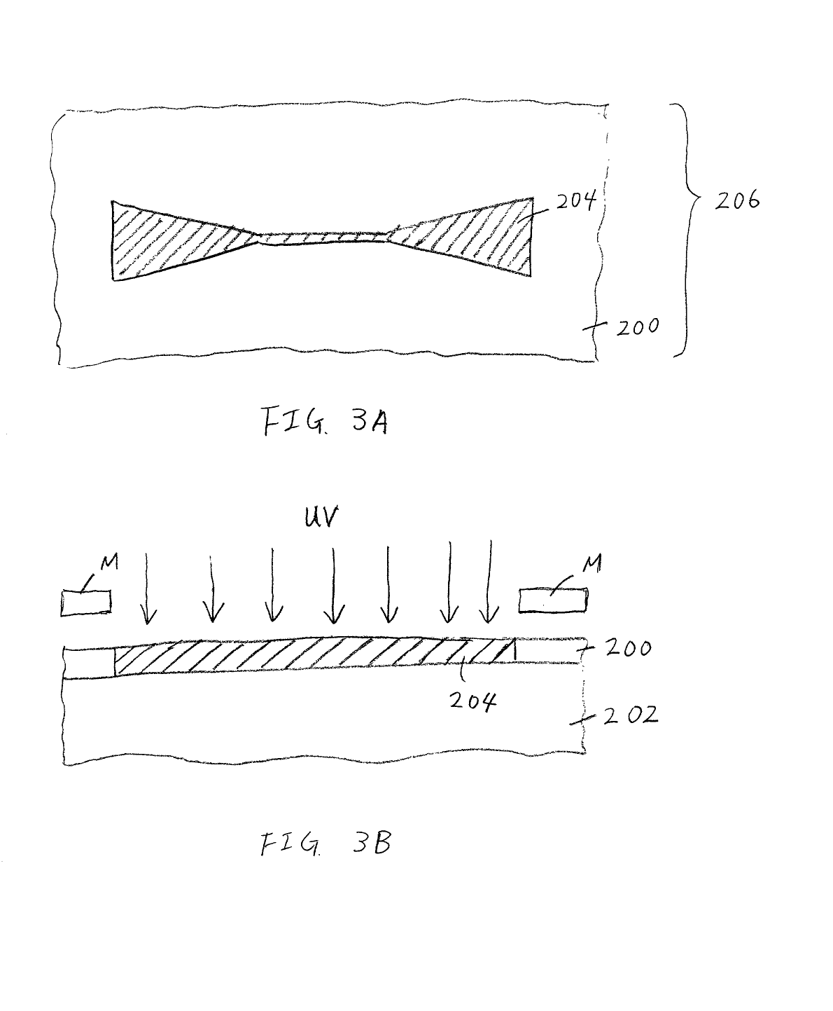

Subsequent to forming lead-silicate-containing film 200 on substrate 202, a predetermined portion 204 of lead-silicate-containing film 200 is exposed to UV light through a patterned mask, as illustrated at step 104 of FIG. 1 and in FIGS. 3A and 3B. The patterned mask is labeled “M” in FIG. 3B, where the arrows indicate UV light exposure through patterned mask M. By exposing predetermined portion 204 to UV light, the refractive index of predetermined portion 204 is modified, thereby forming a refractive-index-patterned lead-silicate-containing film 206. Such an exposure can be referred to as “UV imprinting.”

Any suitable UV exposure conditions that provide the desired refractive index modification of predetermined portion 204 can be employed. For example, the wavelength of UV light can be in the range of 200 nm to 350 nm, and the UV exposure can be conducted at an exposure in the range of 10 mJ/cm ² to 100 mJ/cm² for a total exposure time in the range of 10 microseconds to 100 microseconds. Furthermore, any suitable UV light source can be employed (e.g., an excimer laser).

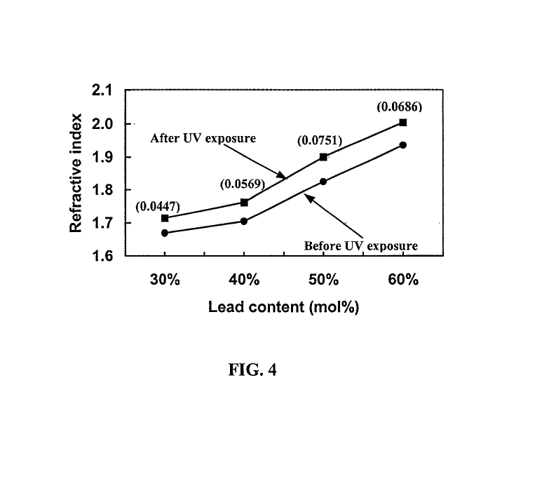

FIG. 4 graphically shows the dependence of the refractive index of exemplary photosensitive lead-silicate-containing films on the lead content therein, both before and after exposure to 248 nm UV light from a KrF excimer laser. The UV exposure employed in the data of FIG. 4 is 2,000 illuminations at an exposure density of approximately 60 mJ/cm², a frequency of 20 Hz and a pulse width of 20 nanoseconds. The largest refractive index modification illustrated in FIG. 4 is approximately 0.075 . This degree of modification is large enough to form a refractive-index-patterned lead-silicate-containing film that is useful in a wide variety of optical devices. For example, the refractive-index-patterned lead-silicate-containing film can be used to form integrated gratings, channel waveguides, or buried channel waveguides of small dimensions and small bending radius. Such large refractive index modification upon exposure to UV light enables the manufacturing of photonic integrated circuits with a high packing density.

The patterned mask employed in processes according to the present invention can be a patterned amplitude mask, patterned phase mask or patterned gray scale mask. Such patterned masks are typically placed within 0.2 microns to 2.0 microns of the substrate during the exposure step. When a patterned amplitude mask with a UV transparent region and a UV non-transparent portion is employed, a predetermined portion 204 of lead-silicate-containing film 200 placed under the transparent region is exposed to UV light. The refractive index of the predetermined portion is, therefore, modified (i.e., increased) in comparison to the remainder of the photosensitive lead-silicate-containing film.

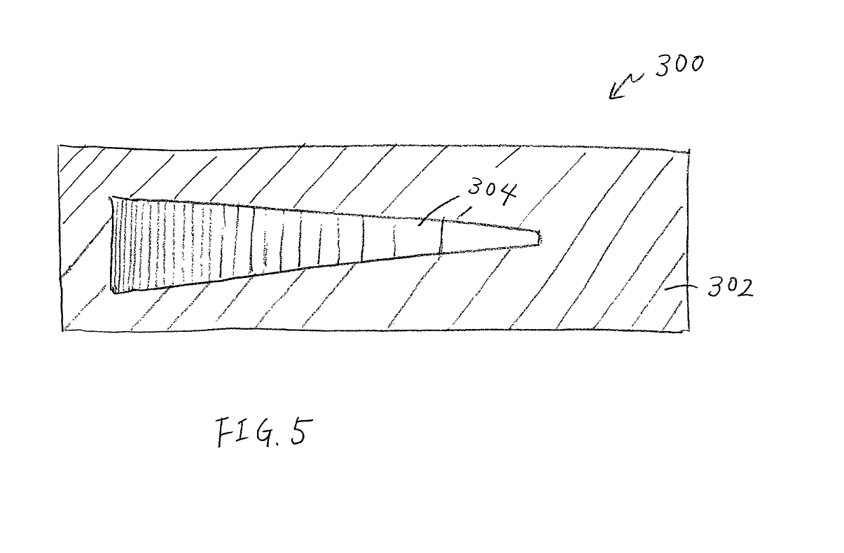

A patterned gray scale mask 300 is a patterned mask that includes a UV non-transparent region 302 and a “gray scale” region 304 (i.e., a region with a UV transparency that changes gradually from completely UV transparent to nearly UV opaque), as illustrated in FIG. 5. The relative degree of UV transparency in gray scale region 304 is represented by the density of vertical cross-hatching. When such a patterned gray scale mask is employed in a process according to one exemplary embodiment of the present invention, the predetermined portion of the photosensitive lead-silicate-containing film placed under gray scale region 304 will receive a lateral (i.e., in the horizontal direction) graded exposure to UV light. Since the degree of refractive index modification that occurs in the predetermined portion is a function of UV exposure (i.e., UV dosage), such a lateral graded exposure to UV light will result in the predetermined portion of the photosensitive lead-silicate-containing film having a lateral graded refractive index. Furthermore, since the degree of refractive index modification that occurs in predetermined portion 204 is a function of UV exposure, the refractive index modification that occurs upon UV exposure can be controlled by adjusting the intensity of UV light, as well as the total exposure time.

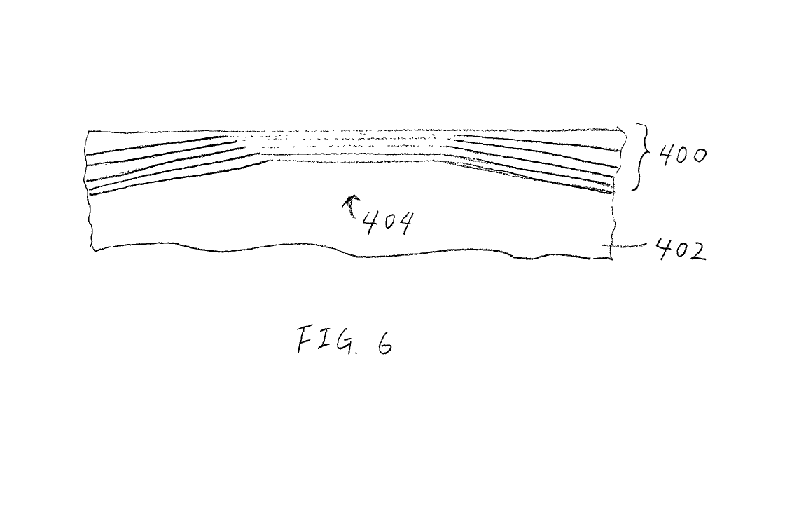

Processes in accordance with the present invention can optionally include forming a multi-layered photosensitive lead-silicate-containing film 400 on a substrate 402 that includes a sloped upper surface protrusion 404 (e.g., a “hill”), as illustrated in FIG. 6. Sloped upper surface protrusion 404 can be formed using conventional photolithography and dry etching of a silica-on-silicon substrate. Multi-layered photosensitive lead-silicate-containing film 400 can be formed using a sol-gel technique that includes multiple iterations of spin-coating and annealing that result in a gradual layer-by-layer change from a conformal coating to a planarized coating. In this circumstance, the photosensitive lead-silicate-containing film and any refractive-index-patterned lead-silicate-containing film formed therefrom by UV exposure will be vertically tapered (i.e., thinned) over the sloped upper surface protrusion.

Once apprised of the present disclosure, one skilled in the art will recognize that methods in accordance with the present invention can be employed to manufacture a wide variety of optical devices (e.g., integrated gratings, channel waveguides and buried channel waveguides).

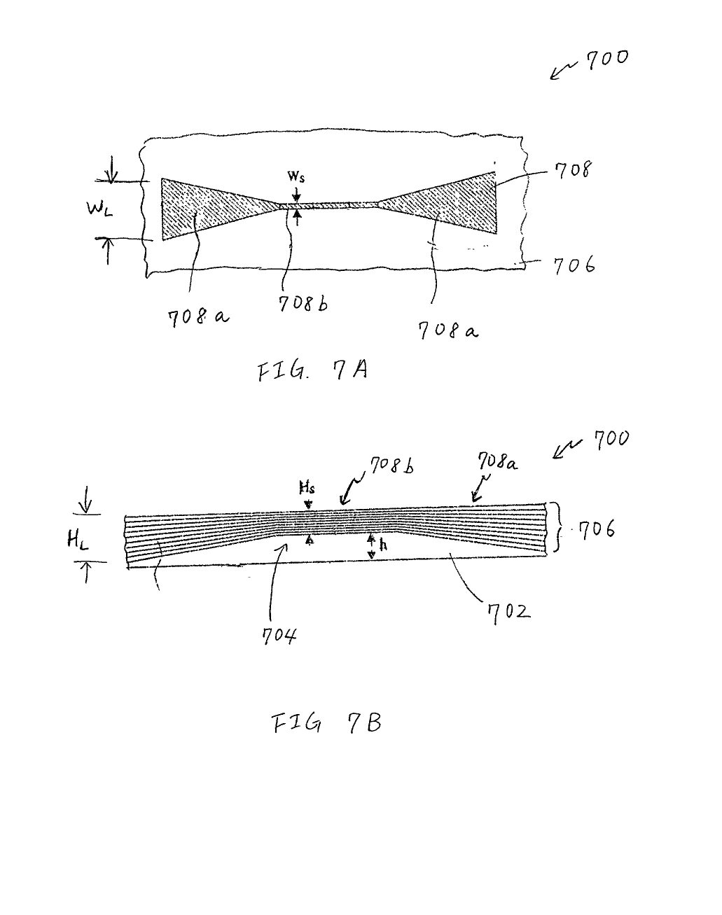

FIGS. 7A and 7B depict a vertically tapered waveguide 700 that can be manufactured using the methods described above. Vertically tapered waveguide 700 includes a substrate 702 with a sloped upper surface protrusion 704. Sloped upper surface protrusion 704 can be of any suitable dimensions, such as a length of approximately 100 microns and a height (h) of 5 microns.

A refractive-index-patterned lead-silicate-containing film 706 is disposed on substrate 702 and sloped upper surface protrusion 704 such that refractive-index-patterned lead-silicate containing film 706 is vertically tapered (i.e., thinned) over sloped upper surface protrusion 704. Refractive-index-patterned lead-silicate-containing film 706 includes a predetermined portion 708 that has had its refractive index modified by exposure to UV light through a patterned mask. If desired, predetermined portion 708 can have a lateral graded refractive index created as described above. In addition, refractive-index-patterned lead-silicate-containing film 706 can be multi-layered, as illustrated in FIG. 7B, and have a vertical refractive index distribution.

Predetermined portion 708 includes laterally tapered portions 708a that terminate with a width W_{L}, as shown in FIG. 7A. Laterally tapered portions 708a can be employed to couple a large dimension weak confinement channel waveguides with a width W_{L} and height H_{L} that match a single mode fiber (not shown) to another predetermined portion 708b with a width Wₛ and height Hₛ that is matched to a III-V semiconductor waveguide (not shown).

It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for the formation of a refractive-index-patterned film for use in optical device manufacturing, the method comprising:
forming a photosensitive lead-silicate-containing film on a substrate; and
exposing a predetermined portion of the photosensitive lead-silicate-containing film to ultra-violet (UV) light through a patterned mask,
whereby the refractive index of the predetermined portion of the photosensitive lead-silicate-containing film is modified and a refractive-index-patterned lead-silicate-containing film is thereby formed.

2. The method of claim 1 further comprising, during the forming step, forming a photosensitive lead-silicate-containing film that includes a dopant selected from the dopant group consisting of germanium, titanium, boron, phosphorus, rare earth elements and combinations thereof.

3. The method of claim 1 further comprising, during the forming step, forming a photosensitive lead-silicate-containing film that has a lead content in the range of 30 molar percent to 60 molar percent.

4. The method of claim 1 further comprising, during the forming step, forming the photosensitive lead-silicate-containing film using a sol-gel technique.

5. The method of claim 1 further comprising, during the forming step, forming the photosensitive lead-silicate-containing film by employing a deposition technique selected from the deposition technique group consisting of flame hydrolysis deposition techniques, chemical vapor deposition techniques, sputtering deposition techniques, thermal evaporation deposition techniques, and electron beam evaporation deposition techniques.

6. The method of claim 1 further comprising, during the forming step, forming a photosensitive lead-silicate-containing film on a substrate selected from the substrate group consisting of quartz, silica-on-silicon, gallium arsenide (GaAs), indium phosphide (InP), gallium nitride (GaN), lithium niobate (LiNbO₃), barium titanate (BaTiO₃) and sapphire (Al₂O₃) substrates.

7. The method of claim 1, wherein the exposing step employs UV light with a wavelength in the range of 200 nm to 350 nm.

8. The method of claim 1, wherein the exposing step modifies the refractive index of the predetermined portion by approximately 0.44 to 0.75 refractive index units.

9. The method of claim 1, wherein the exposing step employs a patterned amplitude mask.

10. The method of claim 1, wherein the exposing step employs a patterned gray scale mask.

11. The method of claim 10, wherein the exposing step forms a refractive-index-patterned lead-silicate-containing film with a lateral graded refractive index.

12. The method of claim 1 further comprising, during the forming step, forming a photosensitive lead-silicate-containing film with a vertical refractive index distribution.

13. The method of claim 12 further comprising, during the forming step, forming a multi-layered lead-silicate-containing film using a sol-gel technique that includes multiple iterations of spin-coating and thermal annealing.

14. The method of claim 1 further comprising, during the forming step, forming a photosensitive lead-silicate-containing film on a substrate that includes a sloped upper surface protrusion such that the photosensitive lead-silicate-containing film is vertically tapered over the sloped upper surface protrusion.

15. A vertically tapered waveguide region comprising:
a substrate with a sloped upper surface protrusion ; and
a refractive-index-patterned lead-silicate-containing film disposed on the substrate and sloped upper surface protrusion,
wherein the refractive-index-pattered lead-silicate containing layer is vertically tapered over the sloped upper surface protrusion.

16. The vertically tapered waveguide region of claim 15, wherein the refractive-index-patterned lead-silicate-containing layer has a vertical refractive index distribution.

17. The vertically tapered region of claim 15, wherein the refractive-index-patterned lead-silicate-containing layer includes a predetermined portion with a lateral graded refractive index.

18. The vertically tapered waveguide of claim 15, wherein the refractive-index-patterned lead-silicate-containing layer includes a laterally tapered predetermined portion.
